(19) United States
(12) Patent Application Publication
(10) Pub. No.: US 2021/0059222 A1
(43) Pub. Date: Mar. 4, 2021

(54) USE OF ELECTRIC SHOCK TO PREVENT ANTS AND OTHER CRAWLING INSECTS FROM GAINING ACCESS TO HUMMINGBIRD AND OTHER TYPES OF BIRD FEEDERS

(71) Applicants: Kevin Lee Hanson, Colfax, IA (US); Andrea Michelle Hanson, Colfax, IA (US)

(72) Inventors: Kevin Lee Hanson, Colfax, IA (US); Andrea Michelle Hanson, Colfax, IA (US)

(21) Appl. No.: 17/001,786

(22) Filed: Aug. 25, 2020

Related U.S. Application Data
(60) Provisional application No. 62/893,143, filed on Aug. 28, 2019.

(51) Int. Cl. A01K 39/01; A01M 29/28; A01M 1/22

(52) U.S. Cl. CPC A01K 39/0113; A01M 1/223; A01M 29/28

(57) ABSTRACT

An electric shock system for a bird feeding device includes a main body having a top wall, a side wall, and a bottom wall with an opening. A battery holder is disposed within the main body and retains a battery. A conductor array is positioned between the battery holder and the side wall and is connected to the battery.

### CROSS REFERENCE TO RELATED APPLICATION

This application claims the benefit of the priority of U.S. Provisional Application No. 62/893,143 filed on Aug. 28, 2019, the contents of this application is hereby incorporated by reference in its entirety.

### BACKGROUND OF THE INVENTION

Many people around the world put bird feeders out every year to attract a wide variety of birds. Many of these birds are attracted to sweet things like grape jelly, fruit and liquid nectar. There are a wide variety of bird feeders on the market to dispense these types of sweet food. The problem with sweet food is, it also attracts ants and other crawling insects. These insects invade the feeder and sometimes even affect the palatability of the food being dispensed. Some bird feeders may require daily or bi-weekly maintenance in the way of cleaning and replacing old food with fresh. This task is also complicated when the feeder is covered with ants and other crawling insects.

There are many inventions on the market trying to stop ants and crawling insects from gaining access to bird feeders. For example, ants do not like to cross water. One of the most common methods is the water moat. This method often requires daily maintenance by having to refill the moat because of water loss due to wind and/or evaporation. This method does not work well unless you are able to conduct the maintenance required. If the moat goes dry, the crawling insects return. Sometimes people add a type of oil to the surface of the water to help inhibit evaporation and increase the barrier of protection. This creates a new mess to contend with.

A second common method is where you apply petroleum jelly or some form of grease to something in the path the ants take to the feeder. This method is also messy and requires maintenance. A third method uses a Permethrin covered disk. Permethrin is a synthetic insecticide. This method does not require any maintenance and seems to work well but it must be replaced yearly. Accordingly, there exists a need in the art for a device that addresses these problems and deficiencies.

An objective of the present invention is to provide an electric shock system to prevent ants and similar insects from gaining access to bird feeders.

Another objective of the present invention is to provide an electric shock system that requires little, if any, maintenance.

These and other objectives will be apparent to those having ordinary skill in the art based upon the following written description, drawings, and claims.

### SUMMARY OF THE INVENTION

What is clearly needed is a maintenance and poison free way to keep ants and other crawling insects from gaining access to bird feeders. The invention is maintenance free and does not use poison or messy grease and oil and includes an electric shock system for a bird feeding device. The system includes a main body having a top wall, a side wall, and a bottom wall with an opening. The bottom wall is removably connected to the side wall. A battery holder is disposed within the main body and retains a battery. The battery holder is connected to and extends downwardly from the top wall of the main body. The main body is connected to a top or a bottom of a bird feeding device.

A conductor array is positioned between the battery holder and the side wall and is connected to the battery. Preferably, the conductor array is connected to and extends downwardly from the top wall of the main body. In one example the conductor array includes a first cylinder and a second cylinder separated by an insulating material.

A first hook is connected to, or integral with, the top wall of the main body. A second hook is connected to, or integral with, the battery holder. The second hook extends downwardly from and through the opening in the bottom wall. Alternatively, the system includes a shaft that extends through the main body. In this embodiment the battery holder is attached to the shaft.

### BRIEF DESCRIPTION OF THE DRAWINGS

FIG. 1 is a side sectional view of an electric shock system;

FIG. 2 is an exploded perspective view of a conductor array;

FIG. 3 is a perspective view of a battery holder;

FIG. 4 is a side sectional view of an electric shock system;

FIG. 5 is a perspective view of a conductor array;

FIG. 6 is a perspective view of a battery holder;

FIG. 7 is a perspective view of a main body;

FIG. 8 is a side sectional view of an electric shock system;

FIG. 9 is a side sectional view of an electric shock system;

FIG. 10 is a side sectional view of an electric shock system; and

FIG. 11 is a side sectional view of an electric shock system.

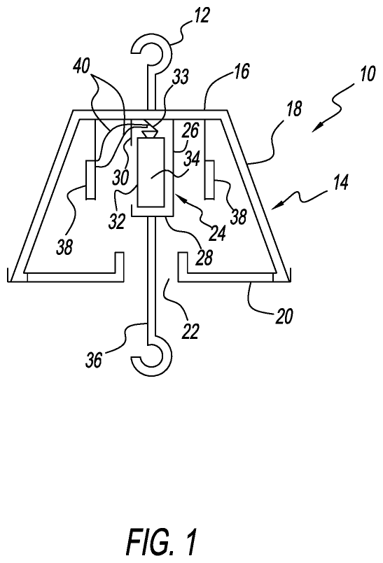

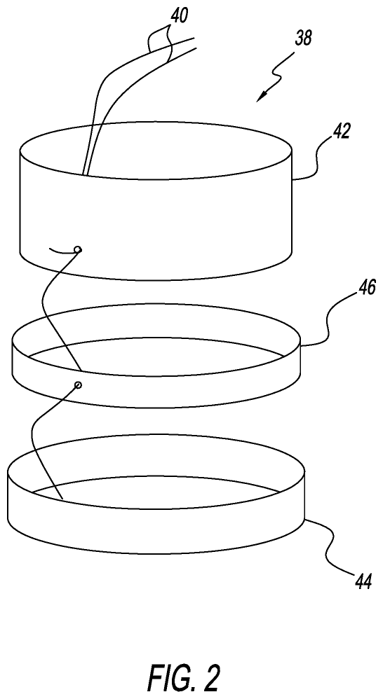

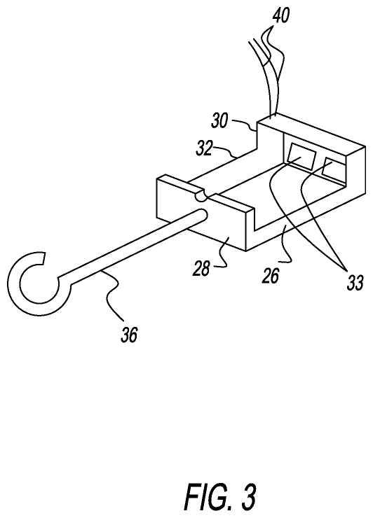

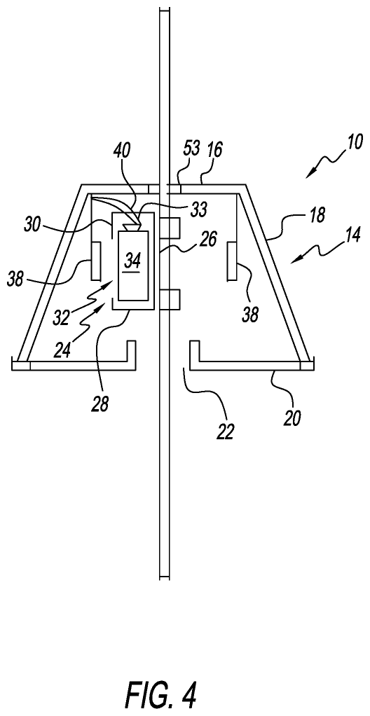

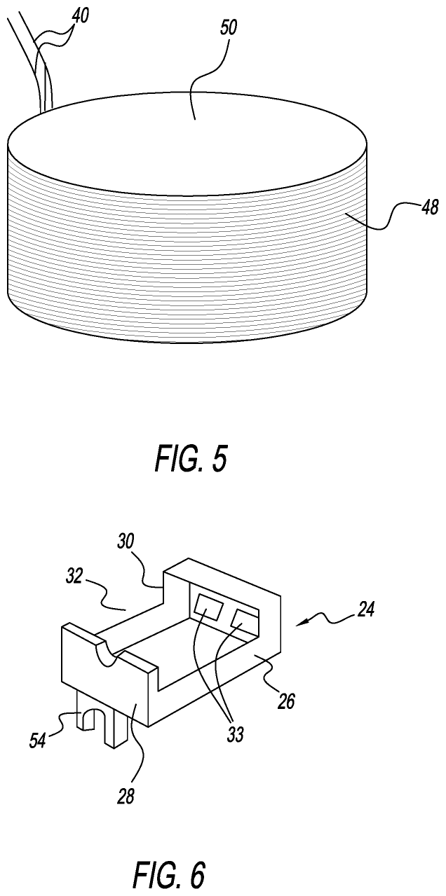

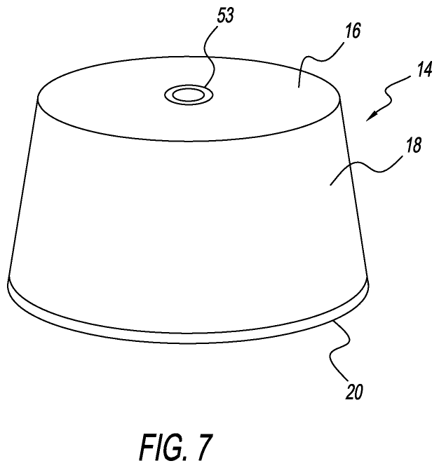

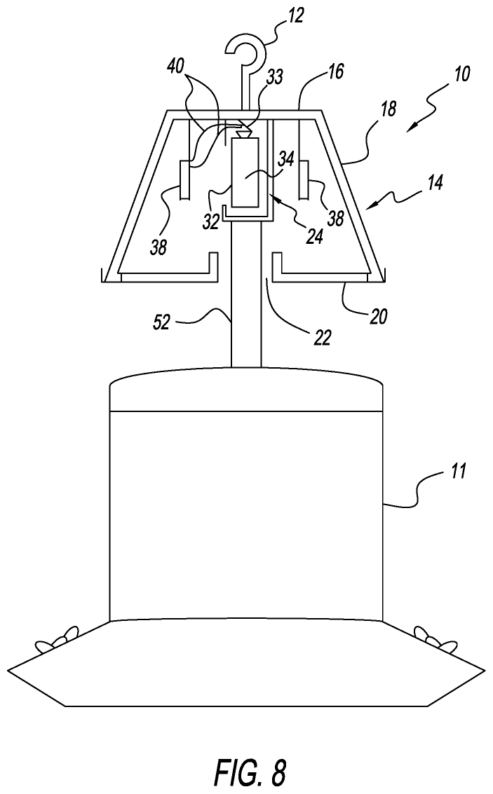

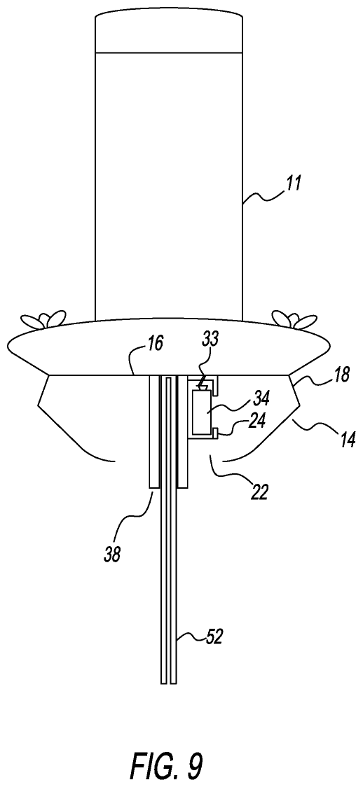

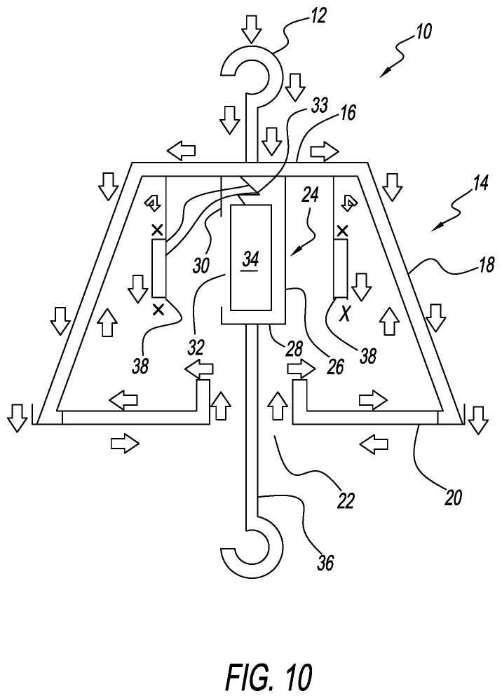

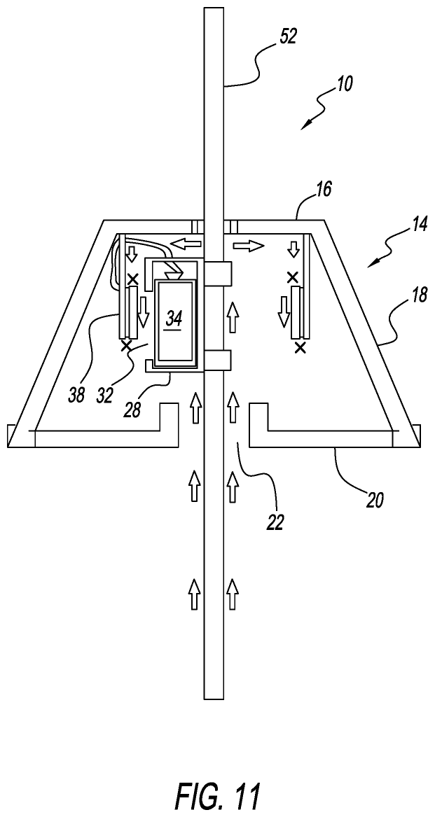

### DETAILED DESCRIPTION

Referring to the Figures, an electric shock system 10 is shown that prevents crawling insects from gaining access to the food supplied by bird feeders 11. The present invention is described in enabling detail, in the following examples, which represent more than one embodiment of the present invention.

The electric shock system 10 includes a top or first hook 12 used to hang a bird feeding device. The hook 12 is just one example of how the bird feeding device 11 can be hung, as other known devices are used as well. The hook is of any material including, but not limited to plastic, fiberglass, wood, metal or the like, as well as any combination of these materials. Connected to the hook 12 is a main body or container 14. Preferably, the main body 14 is made of plastic. The hook 12 and main body 14 can be made separately or combined as an integral piece. The main body 14 is of any shape and is made of any material including, but not limited to, glass, plastic, fiberglass, wood, metal, ceramic, or the like, or any combination of these materials.

Generally, the main body 14 has a top wall 16, side walls 18, and a bottom wall 20 with an opening 22. Alternatively, the main body 14 has an open bottom. Disposed within the main body 14 is a battery holder 24. While the battery holder is of any size, shape and structure, in the example shown, the battery holder 24 has a vertical support member 26 connected to the top wall 16 that extends downwardly away from the top wall 16 and terminates in a horizontal support member 28. A second vertical support member 30 is also connected to the top wall 16 and extends downwardly away from the top wall in spaced relation to the first vertical support member 26. A side opening 32 is positioned between the second vertical support 30 and the horizontal support member 28 and battery contacts 33 are positioned on the top wall 16.

Positioned within the battery holder 24 is a battery 34 such as a 9-volt battery, however, the system can be powered by any conventional power configuration. Connected to and extending downwardly from the horizontal support member 28 through the opening 22 is a second or bottom hook member 36 from which the bird feeding device 11 will be connected. The bird feeding device can be connected to the system 10 in ways other than a hook.

Conductor arrays 38 are connected to the top wall 16 between the battery holder 24 and the side walls 18 and extend downwardly. The conductor arrays 38 are connected to the battery 34 with a positive and negative wire 40. Preferably the bottom wall 20 snaps on to the side walls 18. Alternatively, bottom wall 20 is screwed on or attached using a twist and lock means.

The conductor arrays 38 of are any size, shape and structure. In one example the conductor array 38 includes a first or inner copper cylinder 42 and a second or outer copper cylinder 44 having a height that is less than the first copper cylinder 42. The second copper cylinder 44 has a diameter larger than the first copper cylinder 42 in order to securely fit insulating material 46 therebetween. One wire 40 is connected to the first copper cylinder 42 and the other wire is connected to the second copper cylinder 44. Alternatively, the conductor array 38 is molded into the main body 14 and connected to the battery 24 in this manner.

In another embodiment, the conductor array 38 includes copper wires 48 that are wrapped around a cylinder 50 and slightly spaced. The wires 48 alternate in polarity across the cylinder to deliver the electric shock. While a cylinder is preferred, the shape of the array is of any type and includes a square, triangle, or flat shape.

In an alternative embodiment, a shaft 52 extends through the main body 14. A rubber grommet 53 is sized to fit snugly to the shaft 52 and the main body 14 to hold the shaft 52 in place. The battery holder 24 is attached to the shaft 52 using rubber grommets 54 and the conductor array 38 surrounds the battery holder 24.

The shock system 10 can be built into the bird feeding device 11 on either the top or the bottom, and the bird feeding device 11 can be detachable for easy cleaning. In operation, once the shock system is activated, the insects will crawl along a path that in one example begins on the first hook 12 as shown by the arrows. From the first hook 12 the insect crawls along the top wall 16 of the main body 14 and down the side wall 18 to the bottom wall 20. From the bottom wall 20 the insect crawls through the opening 22 and proceeds along an inner surface of the bottom wall 20 to an inner surface of the side wall 18, and then to the inner surface of the top wall 16. To continue the insect must crawl down the conductor array 38. While standing on the first conductor in their path, with a given polarity, the insect proceeds to the second conductor of the opposite polarity where the insect receives the first shock. If the insect passes beyond the first shock without retreating, the next shock will occur as the insect crawls around the bottom of the conductor array where the desired retreat response hopefully is achieved.

It will be apparent to one with skill in the art that the device for repelling crawling insects from bird feeders may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the description without departing from the spirit and scope of the present invention.

What is claimed is:

1. An electric shock system for a bird feeding device, comprising:
a main body having a top wall, a side wall, and an open bottom;
a battery disposed within the main body; and
a conductor array connected to the battery and associated with the main body.

2. The system of claim 1 wherein the conductor array is positioned in relation to the main body and adapted to force an insect to cross over the conductor array.

3. The system of claim 1 wherein the conductor array has two or more contacts.

4. The system of claim 1 wherein the conductor array is positioned and adapted to provide an electric shock within the main body.

5. The system of claim 1 further comprising a removable bottom wall with an opening attached to the side wall.

6. The system of claim 1 further comprising a first hook connected to the top wall.

7. The system of claim 1 further comprising a second hook connected to the battery holder and extending through the opening in the bottom wall.

8. The system of claim 1 further comprising a shaft that extends through the main body.

9. The system of claim 4 wherein the battery holder is connected to the shaft.

10. The system of claim 1 wherein the bottom wall is removably connected to the side wall.

11. The system of claim 1 wherein the conductor array includes a first cylinder and a second cylinder separated by an insulating material.

12. The system of claim 1 wherein the main body is connected to a top of the bird feeding device.

13. The system of claim 1 wherein the main body is connected to the bottom of the bird feeding device.

14. An electric shock system for a bird feeding device, comprising:
a main body having a top wall, a side wall, and an open bottom;
a conductor array connected to a battery and positioned and adapted in a path to force an insect to cross over the conductor array.

15. The system of claim 14 wherein the main body is connected to a first hanging mechanism and a second hanging mechanism and the conductor array is positioned in a path between the first hanging mechanism and the second hanging mechanism.
